(19) United States
(12) Patent Application Publication
(10) Pub. No.: US 2011/0004777 A1
(43) Pub. Date: Jan. 6, 2011

(54) DISPLAY CONTROL CIRCUIT AND DISPLAY CONTROL METHOD

(75) Inventor: Shinji OGASAWARA, Kanagawa (JP)

Correspondence Address: YOUNG & THOMPSON, 209 Madison Street, Suite 500, Alexandria, VA, 22314, US

(73) Assignee: NEC ELECTRONICS CORPORATION, Kanagawa (JP)

(21) Appl. No.: 12/796,734

(22) Filed: Jun. 9, 2010

(30) Foreign Application Priority Data
Jul. 6, 2009 (JP) 2009-159621

(51) Int. Cl. G06F 1/32

(52) U.S. Cl. 713/323

(57) ABSTRACT

A display control circuit in accordance with an exemplary aspect of the present invention is including a display memory that stores display data to be displayed on a display device, the display memory being supplied with electric power through a power-supply terminal, a power-supply unit that connects the power-supply terminal to a power-supply or a ground according to a request, and a control unit that requests the power-supply unit to connect the power-supply terminal to a ground when the display memory enters a standby mode in which no displaying is performed on the display device, and requests the power-supply unit to connect the power-supply terminal to a power supply when a predetermined time has elapsed after the request even if the display memory is in the standby mode.

### INCORPORATION BY REFERENCE

This application is based upon and claims the benefit of priority from Japanese patent application No. 2009-159621, filed on Jul. 6, 2009, the disclosure of which is incorporated herein in its entirety by reference.

### BACKGROUND

1. Field of the Invention

The present invention relates to a display control circuit and a display control method, in particular, a technique to reduce the power consumption in a display memory that stores display data to be displayed in a display device.

2. Description of Related Art

LCD driver-ICs (Integrated Circuits), which are used to control display on LCD (Liquid Crystal Display) devices, are equipped with a display memory to store data to be displayed on the LCD devices. As the number of pixels on a LCD device has increased, the storage capacity of the display memory has been also increasing. As a result, due to the miniaturization of manufacturing processes, the off-leak current in memory cells included in the display memory has increased.

Japanese Unexamined Patent Application Publication No. 2006-146998 discloses a memory equipped with a power-supply control circuit corresponding to a plurality of memory banks composed of a plurality of memory blocks. The memory block constituting the memory bank is equipped with a validity bit. When the validity bit of all the memory blocks included in a memory bank indicates that the data written in the memory blocks are invalid data, the power-supply to that memory bank is turned off. In this way, the off-leak current can be reduced to a small value with simple control without increasing the circuit area.

However, in the technique disclosed in Japanese Unexamined Patent Application Publication No. 2006-146998, there is a problem that when valid data is to be written to a memory bank that is in a power-off state, it requires a preparation time to turn on the power supply to that memory bank and thereby to make the memory back available for use. In the case of folding-type mobile phones, for example, it is necessary to display an image on the screen instantly when the mobile phone is unfolded. If the technique disclosed in Japanese Unexamined Patent Application Publication No. 2006-146998 is applied to such a mobile phone, the off-leak current can be reduced by turning off the power-supply to a memory bank(s) while the mobile phone is in a folded state. However, it requires a preparation time to make the display memory available for use after the mobile phone is unfolded. Therefore, there is a problem that the process to store data to be displayed on the screen in the display memory and then to display an image on the screen based on this stored data cannot be carried out within a required time.

Meanwhile, Japanese Unexamined Patent Application Publication No. 2000-357400 discloses a technique that can perform screening to detect a data retention failure without disconnecting the memory cell from an external power supply by using a regulator circuit capable of bringing the memory cell into a standby state by lowering the voltage of the external power supply supplied to the memory cell. Further, with this configuration, a user can easily perform control in accordance with the use map of the memory blocks so that the power consumption is reduced. Furthermore, Japanese Unexamined Patent Application Publication No. 03-101163 discloses a static RAM (Random Access Memory) capable of minimizing its power consumption in a standby state by supplying a current from the power supply to the memory cell through an electric resistance in the standby state. In this way, the data can be retained for a long time even when the static RAM is used in a mobile electronic device having a limited life of the power supply.

### SUMMARY

As described above as the related art, the method, which reduces electric power consumed by the off-leak current by turning off the power supply to a display memory until the display memory is actually used, requires a preparation time to make the display memory available for use. Therefore, this method suffers from a problem that it requires the preparation time of the display memory in order to display data.

A first exemplary aspect of the present invention is a display control circuit including: a display memory that stores display data to be displayed on a display device, the display memory being supplied with electric power through a power-supply terminal; a power-supply unit that connects the power-supply terminal to a power supply or a ground according to a request; and a control unit that requests the power-supply unit to connect the power-supply terminal to a ground when the display memory enters a standby mode in which no displaying is performed on the display device, and requests the power-supply unit to connect the power-supply terminal to a power supply when a predetermined time has elapsed after the request even if the display memory is in the standby mode.

Another exemplary aspect of the present invention is a display control method to display display data stored in a display memory on a display device, the method including: lowering a voltage value in a memory cell included in the display memory when the display memory enters a standby mode in which no displaying is performed on the display device; and supplying electric power to the memory cell after the voltage value in the memory cell has been lowered for a predetermined time even if the display memory is in the standby mode.

In accordance with each of the above-described exemplary aspects of the present invention, it has been found out from the experience of the inventors of the present application that electric power consumed by the off-leak current is reduced in comparison to the case where the display memory is continuously supplied with electric power. Therefore, in accordance with each of the above-described exemplary aspects of the present invention, it is possible to display data by using a display memory without requiring the preparation time of the display memory while reducing the electric power consumed by the off-leak current in the display memory.

In accordance with each of the above-described exemplary aspects, the present invention can provide a display control circuit and a display control method capable of displaying data by using a display memory without requiring the preparation time of the display memory while reducing the electric power consumed by the off-leak current in the display memory.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a configuration diagram of a display control device in accordance with an exemplary embodiment of the present invention;

FIG. 2 is a circuit diagram of a regulator circuit in accordance with an exemplary embodiment of the present invention;

FIG. 3 is a timing chart illustrating an operation in accordance with an exemplary embodiment of the present invention; and

FIG. 4 shows an example of a memory cell in accordance with an exemplary embodiment of the present invention.

### DETAILED DESCRIPTION OF THE EXEMPLARY EMBODIMENTS

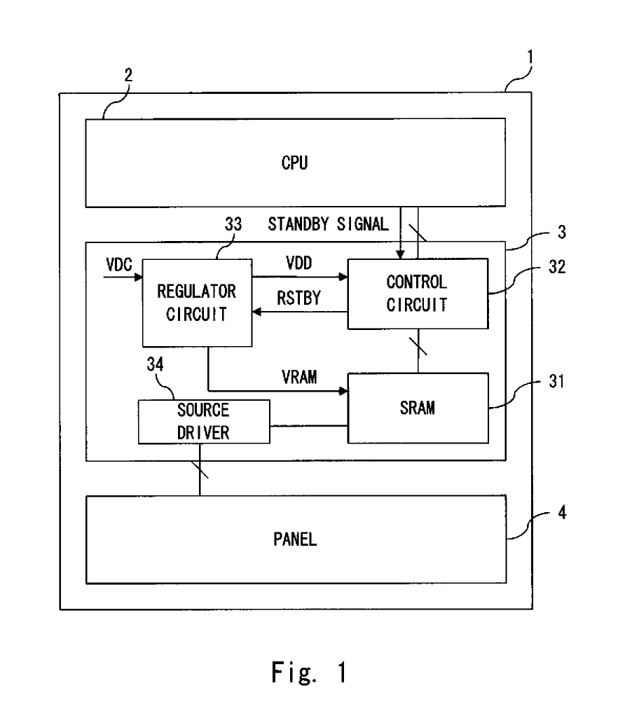

Exemplary embodiments of the present invention are explained with reference to the drawings. Firstly, a configuration of a display control device in accordance with an exemplary embodiment of the present invention is explained with reference to FIG. 1. FIG. 1 is a configuration diagram of a display control device in accordance with an exemplary embodiment of the present invention.

A display control device 1 includes a CPU (Central Processing Unit) 2, a driver-IC 3, and a panel 4. The CPU 2 outputs display data to be displayed on the panel 4, an instruction on On/Off of the displaying state on the panel 4, and an instruction on the displaying method such as an instruction for displaying an image in a certain area of the panel 4 to a control circuit 32 of the driver-IC 3.

The driver-IC 3 includes an SRAM 31, a control circuit 32, a regulator circuit 33, and a source driver 34. The SRAM (Static Random Access Memory) 31 stores display data to be displayed on the panel 4. The SRAM 31 corresponds to the display memory. The control circuit 32 stores display data output from the CPU 2 in the SRAM 31. Further, the control circuit 32 outputs display data stored in the SRAM 31 to the source driver 34 according to an instruction from the CPU 2. The control circuit 32 functions as a control unit. The regulator circuit 33 is supplied with electric power VDC from a power supply (not shown). The regulator circuit 33 supplies electric power VRAM to the SRAM 31 based on the electric power VDC supplied from the power supply, and also supplies electric power VDD to the control circuit 32. The regulator circuit 33 functions as a power-supply unit. The source driver 34 generates a voltage according to display data acquired from the SRAM 31 by performing a D/A (Digital to Analog) conversion on the display data. The source driver 34 displays the display data on the panel 4 by applying the generated voltage to the panel 4.

Display data stored in the SRAM 31 is displayed on the panel 4. The panel 4 is a display device such as an LCD and an organic EL (Organic Electroluminescence) display.

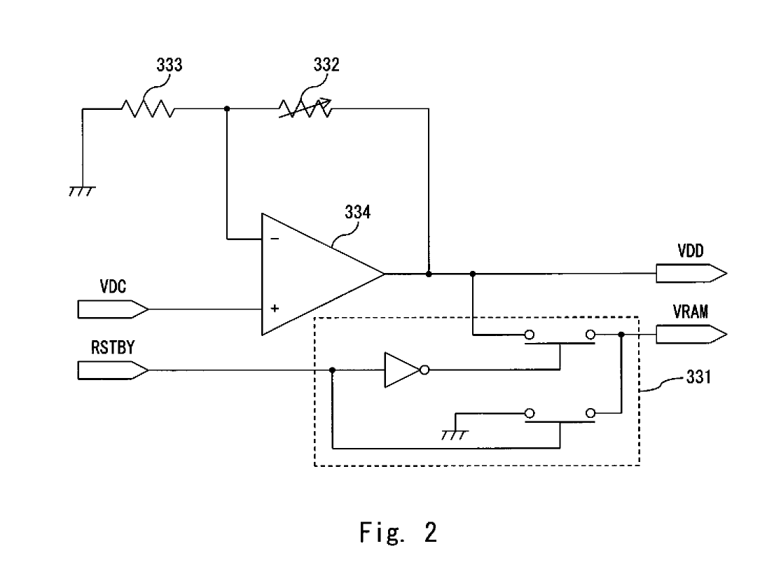

Next, a configuration of a regulator circuit in accordance with an exemplary embodiment of the present invention is explained with reference to FIG. 2. FIG. 2 is a configuration diagram of a regulator circuit in accordance with an exemplary embodiment of the present invention.

The regulator circuit 33 includes a switch 331, a variable resistor 332, a resistor 333, and an amplifier circuit 334. The switch 331 controls whether power VRAM based on the power VDC output from the power supply to the SRAM 31 should be supplied to the SRAM 31 or not according to the value of an RSTBY signal input from the control circuit 32. In other words, the switch 331 controls whether a signal line that is used to supply the power VRAM to the SRAM 31 should be short-circuited to the GND (ground) or not according to the value of the RSTBY signal input from the control circuit 32. Specifically, the SRAM 31 includes a power-supply terminal (not shown) to receive electric power supplied for the memory cell (not shown) included in the SRAM 31. The switch 331 connects this power-supply terminal to the power supply or the GND. The variable resistor 332 adjusts the voltages of the power VDD and the power VRAM. The resistor 333 is a load resistance. The amplifier circuit 334 amplifies the power VDC and outputs the amplified power.

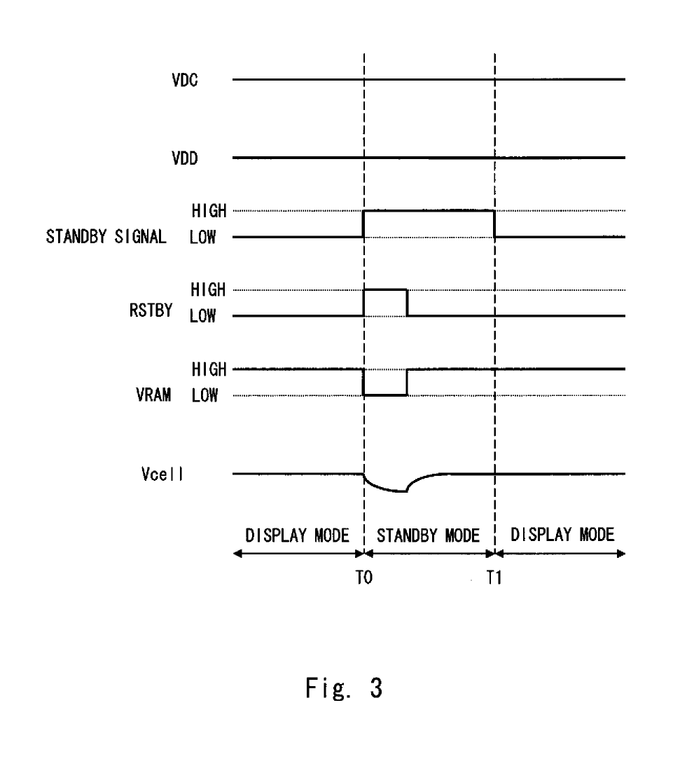

Next, an operation of a display control device in accordance with an exemplary embodiment of the present invention is explained with reference to FIGS. 1 to 4. FIG. 3 is a timing chart illustrating an operation of a display control device in accordance with an exemplary embodiment of the present invention.

Firstly, when the SRAM 31 changes from a display mode in which display data is displayed on the panel 4 to a standby mode in which no displaying is performed and the power consumption is thereby reduced, the CPU 2 brings the standby signal to a High level and outputs the High-level standby signal to the control circuit 32 (T0). Upon reception of the High-level standby signal from the CPU 2, the control circuit 32 stops outputting display data from the SRAM 31 to the source driver 34. Then, the control circuit 32 brings to the RSTBY signal to a High level and outputs the High-level RSTBY signal to the regulator circuit 33. Upon reception of the High-level RSTBY signal from the control circuit 32, the regulator circuit 33 switches the switch 331 to connect the power-supply terminal of the SRAM 31 to the GND.

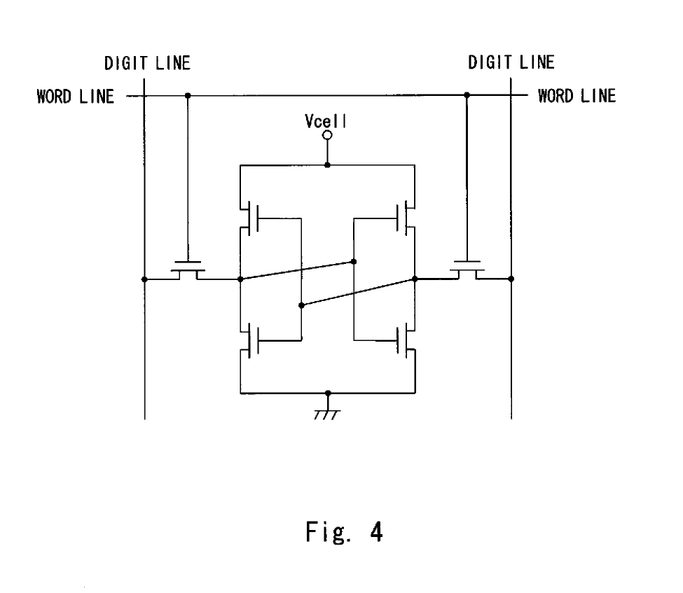

Note that the connection between the power-supply terminal of the SRAM 31 and the GND is maintained for a predefined time. The predefined time is a time required to sufficiently lower the level of an electrical charge charged in the memory cell included in the SRAM 31. Details of the time are explained hereinafter by using an example of a memory cell shown in FIG. 4. When the power VRAM is being supplied to the power-supply terminal of the SRAM 31, the voltage value Vcell of the memory cell is a voltage value necessary for the operation of the memory cell based on the power VRAM. That is, the predefined time is a time required for this memory cell to sufficiently lower the voltage value Vcell. The predefined time is preferably a time required for the voltage value Vcell of the memory cell to become zero. Note that the time may be determined based on a measurement result obtained in advance by measuring a time necessary for the memory cell to sufficiently lower the voltage value Vcell and thereby to reduce the electric power consumed by the off-leak current.

When the predefined time has elapsed, the control circuit 32 brings the RSTBY signal to a Low level and outputs the Low-level RSTBY signal to the regulator circuit 33. Upon reception of the Low-level RSTBY signal from the control circuit 32, the regulator circuit 33 switches the switch 331 to connect the power-supply terminal of the SRAM 31 to the power supply. As a result, the power VRAM is supplied to the SRAM 31. At this point, the memory cells included in the SRAM 31 do not necessarily settle down in a state where every memory cell indicates a value 0, but do settle down in a state where each memory cell indicates either a value 0 or a value 1.

Then, when the SRAM 31 changes to a display mode, the CPU 2 brings the standby signal to Low levels and outputs the Low-level standby signal and display data to the control circuit 32 (T1). Upon reception of the display data from the CPU 2, the control circuit 32 stores the display data in the SRAM 31. Further, upon reception of the Low-level standby signal from the CPU 2, the control circuit 32 restarts outputting the display data from the SRAM 31 to the source driver 34. Then, the source driver 34 applies a voltage to the panel 4 according to display data output from the SRAM 31. In this way, the source driver 34 displays the display data on the panel 4.

It has been found out from the experience of the inventors of the present application that when an electrical charge in a memory cell(s) included in the SRAM 31 is discharged and then the SRAM 31 is operated again by supplying power VRAM to the SRAM 31, the electric power consumed by the off-leak current is reduced in comparison to the case where the SRAM 31 is operated by continuously supplying the power VRAM to the SRAM 31 without performing the discharging. Further, after the electrical charge is discharged from the memory cell, the SRAM 31 is supplied with the power VRAM even if the SRAM 31 is in a standby mode. Therefore, display data can be written to the SRAM 31 without requiring the preparation time of the SRAM 31. Therefore, in accordance with the exemplary embodiment of the present invention described above, it is possible to display data by using a display memory without requiring the preparation time of the display memory while reducing the electric power consumed by the off-leak current in the display memory.

Note that if the minimum time that the SRAM 31 takes to enter a display mode again after entering a standby mode is already known, the switch 331 may be formed from a transistor(s) whose size is minimized according to that minimum time. A switch formed from a transistor(s) having a small size takes a longer time for the switching in comparison to a switch formed from a transistor(s) having a large size. However, if the minimum time that the SRAM 31 takes to enter a display mode again after entering a standby mode is already known, the size of the transistor may be reduced as long as the switching of the switch 331 and the preparation time in the SRAM 31 supplied with the power VRAM can be completed within this minimum time.

Further, this exemplary embodiment may be preferably applied to a memory manufactured by a manufacturing process finer than 180 nm because the off-leak current increases significantly in that process or finer process. Furthermore, this exemplary embodiment may be more preferably applied to a memory manufactured by a manufacturing process finer than 150 nm because the off-leak current further increases in that process or finer process.

Note that the present invention is not limited to the exemplary embodiments, and various modifications can be made to them without departing from the spirit and scope of the present invention. For example, in the exemplary embodiments, display data is stored in a display memory when the SRAM changes from a standby mode to a display mode. However, when the display memory becomes available for use by supplying electric power to the display memory, display data may be stored in the display memory in advance even if the SRAM is still in the standby mode.

Further, actual configuration of a memory cell(s) included in a display memory is not limited to the example of the exemplary embodiments shown in FIG. 4. For example, the memory cell may be formed with a depletion-type transistor(s), and/or with a resistor(s). Further, the display memory in the exemplary embodiments includes concepts indicating a part of a display memory as well as an entire display memory. For example, the voltage value of only part of memory cells included in a display memory may be lowered when the SRAM enters a standby mode.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A display control circuit comprising:
a display memory that stores display data to be displayed on a display device, the display memory being supplied with electric power through a power-supply terminal;
a power-supply unit that connects the power-supply terminal to a power-supply or a ground according to a request; and
a control unit that requests the power-supply unit to connect the power-supply terminal to a ground when the display memory enters a standby mode in which no displaying is performed on the display device, and requests the power-supply unit to connect the power-supply terminal to a power supply when a predetermined time has elapsed after the request even if the display memory is in the standby mode.

2. The display control circuit according to claim 1, wherein the display control circuit is a driver circuit connected to a CPU that outputs a signal indicating a standby mode.

3. The display control circuit according to claim 1, wherein
the control circuit issues the request by outputting a ground connection signal to the power-supply unit, the ground connection signal indicating whether the power-supply terminal should be connected to the ground or not, and
the power-supply unit makes the connection based on the ground connection signal input from the control unit.

4. The display control circuit according to claim 1, wherein
the power-supply unit include a switch that connects the power-supply terminal to the power supply or the ground, and makes the connection by switching the switch.

5. The display control circuit according to claim 1, wherein when the standby mode is cancelled, the control unit stores display data in the display memory.

6. The display control circuit according to claim 1, wherein the display memory is an SRAM.

7. The display control circuit according to claim 1, wherein the predetermined time is a time required to lower a voltage value in a memory cell included in the display memory to a predetermined value.

8. The display control circuit according to claim 1, wherein a manufacturing process of the memory is finer than 180 nm.

9. A display control method to display display data stored in a display memory on a display device, the method comprising:
lowering a voltage value in a memory cell included in the display memory when the display memory enters a standby mode in which no displaying is performed on the display device; and
supplying electric power to the memory cell after the voltage value in the memory cell has been lowered for a predetermined time even if the display memory is in the standby mode.
